(19) United States
(12) Patent Application Publication
(10) Pub. No.: US 2011/0017789 A1
(43) Pub. Date: Jan. 27, 2011

(54) MUSICAL INSTRUMENT HARNESS AND METHOD OF MANUFACTURE

(76) Inventor: Wendy WELLS, Sunnyside, NY (US)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/841,426

(22) Filed: Jul. 22, 2010

Related U.S. Application Data
(60) Provisional application No. 61/271,560, filed on Jul. 23, 2009.

(51) Int. Cl. A45F 3/14; B23P 19/00

(52) U.S. Cl. 224/250; 29/426.2

(57) ABSTRACT

A harness for supporting an instrument includes: a first strap; a first end piece connected to a first end of the first strap; a second end piece connected to a second end of the first strap; and a second strap. A first end of the second strap is connected to the first strap at an attachment location. A third end piece is connected to a second end of the second strap, a connector pivotally connects the third end piece to the first end piece, and a structure in the first end piece may connect the first strap to the instrument. A first length adjustment system is associated with the first strap and a second length adjustment system is associated with the second strap. The first strap is devoid of hardware along an entirety of a portion of the first strap extending between the first end piece and the attachment location.

### CROSS REFERENCE TO RELATED APPLICATIONS

The present application claims priority to U.S. Provisional Application No. 61/271,560, filed on Jul. 23, 2009, the contents of which are incorporated by reference herein in their entirety.

### FIELD OF THE INVENTION

The invention relates to an adjustable harness and, more particularly, to a dual-shoulder harness for supporting a musical instrument and an associated method of manufacture.

### BACKGROUND

Conventional harnesses for the support of musical instruments are typically uncomfortable and/or so complicated as to be rendered inconvenient. For example, the ubiquitous single-shoulder guitar strap places all of the weight of the instrument on a single shoulder of the user, which causes muscle strain and fatigue. On the other hand, complex multiple-strap musical harnesses commonly include numerous adjusters and, as a result, are difficult to properly and consistently adjust. Moreover, such complex multiple-strap systems are often extremely difficult or even impossible to adjust when worn by the user, due to the fact that the user cannot reach some of the adjusters.

Accordingly, there exists a need in the art to overcome the deficiencies and limitations described hereinabove.

### SUMMARY

In a first aspect of the invention, there is a harness for supporting an instrument, the harness including: a first strap; a first end piece connected to a first end of the first strap; and a second end piece connected to a second end of the first strap. The harness also includes a second strap, wherein a first end of the second strap is permanently connected to the first strap at a location between the first end of the first strap and the second end of the first strap. The harness includes: a third end piece connected to a second end of the second strap; a connector pivotally connecting the third end piece to the first end piece; and a structure in the first end piece structured and arranged to connect the first strap to the instrument, wherein the structure is separate from the connector. The harness also includes: a first length adjustment system associated with the first strap, wherein the first length adjustment system adjusts a position of the instrument relative to a body of a user wearing the harness; and a second length adjustment system associated with the second strap, wherein the second length adjustment system adjusts a distribution of weight amongst two shoulders of the user wearing the harness.

In another aspect of the invention, there is a harness for supporting an instrument, the harness including: a first strap; a first end piece connected to a first end of the first strap; and a second end piece connected to a second end of the first strap. The harness includes a second strap, wherein a first end of the second strap is permanently connected to the first strap at an attachment location between the first end of the first strap and the second end of the first strap. The harness also includes: a third end piece connected to a second end of the second strap; a connector pivotally connecting the third end piece to the first end piece; and a structure in the first end piece structured and arranged to connect the first strap to the instrument, wherein the structure is separate from the connector. The harness includes a first length adjustment system associated with the first strap and a second length adjustment system associated with the second strap. The first strap is devoid of hardware along an entirety of a portion of the first strap extending between the first end piece and the attachment location.

In yet another aspect of the invention, there is a method of making a harness. The method includes: cutting a first piece of material corresponding to the first strap; cutting a second piece of material corresponding to the second strap; and sewing the second piece of material to the first piece of material.

### BRIEF DESCRIPTION OF THE SEVERAL VIEWS OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIGS. 1 and 2 show a harness in accordance with aspects of the invention; and

FIGS. 3 and 4 show aspects of a method of manufacture of a harness in accordance with aspects of the invention.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The invention relates to an adjustable harness and, more particularly, to a dual-shoulder harness for supporting a musical instrument and an associated method of manufacture. In accordance with aspects of the invention, the harness includes first and second straps that are arranged in the shape of a “V” and are worn over respective shoulders of a user. In an exemplary use, opposite ends of the first strap are connected to points of attachment of a musical instrument such as a guitar. In embodiments, a first end of the second strap is fixedly attached to the first strap between the opposite ends of the first strap, and a second end of the second strap is pivotally attached to the first strap at a location proximate the first end of the first strap. According to aspects of the invention, each of the first and second straps is provided with a single length adjustment system which, in conjunction with the geometric design of the harness and attachment mechanisms of the first and second straps, permits the weight of the article being supported to be selectively adjusted amongst the shoulders of the user.

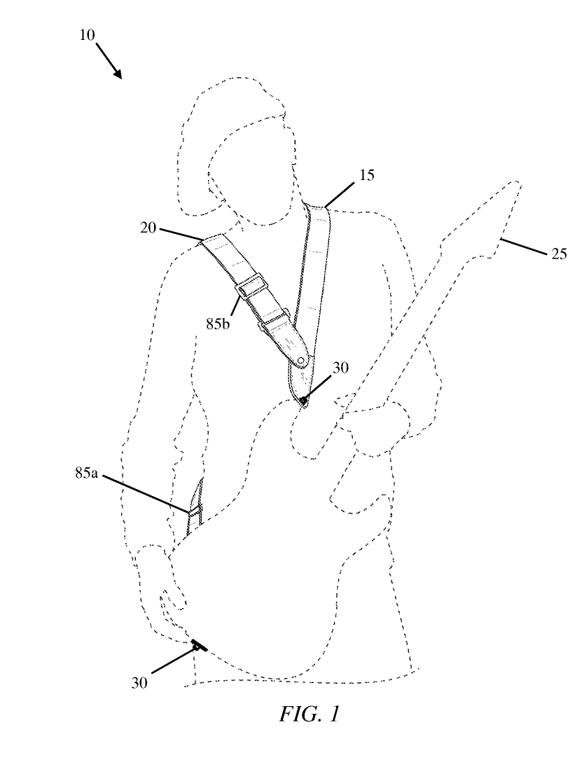

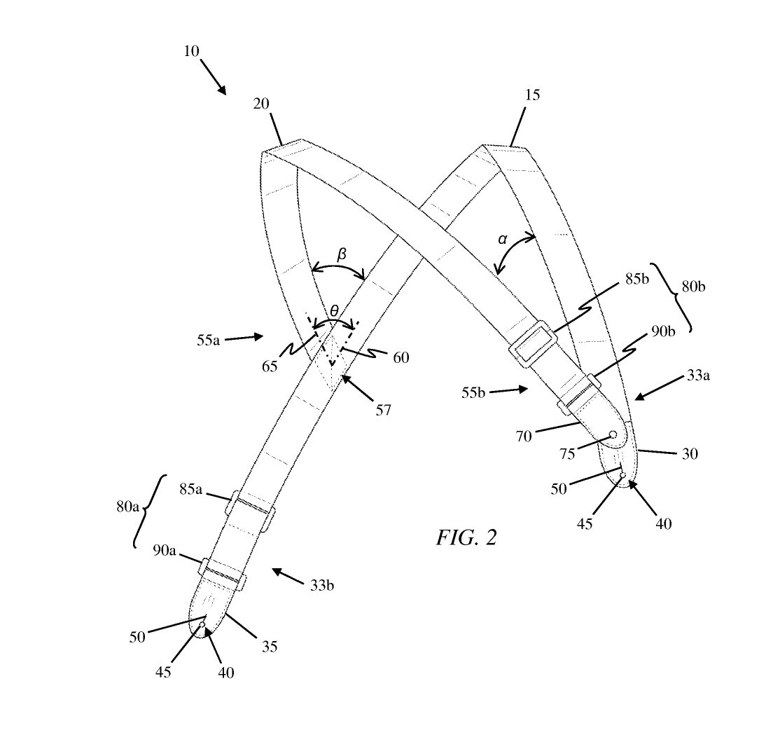

FIGS. 1 and 2 show a harness 10 according to aspects of the invention. In particular, FIG. 1 shows the harness worn by a user and supporting a musical instrument and FIG. 2 shows a view of the harness alone. Although the harness is described herein with respect to a guitar, the invention is not limited to use with a guitar. Rather, embodiments of the invention may be used with any item, such as, but not limited to, any musical instrument, a briefcase, a container, etc. Moreover, embodiments of the invention are shown and described with respect to a right-handed implementation of the harness. However, the invention is not limited to a right-handed implementation, and a left-handed implementation of the invention may also be constructed and used within the scope of the invention, as should be apparent to one of ordinary skill in the art based on the description herein.

With reference to FIG. 1, there is shown a harness 10 comprising a first strap 15 and a second strap 20 worn on respective shoulders of a user for supporting a guitar 25. The user and the guitar are shown in phantom lines. Opposite ends of the first strap 15 are removal connected to anchor points 30 of the guitar 25. such as, for example, guitar buttons which are well known in the art such that further explanation is not believed necessary.

FIG. 2 shows a view of the harness 10 without depicting the user and guitar. In embodiments, and as shown in FIG. 2, a first end piece 30 is connected to a first end 33a of the first strap 15 and a second end piece 35 is connected to a second end 33b of the first strap 15. Each of the first and second end pieces 30, 35 comprises a structure 40 for selectively and removably affixing the harness 10 to the guitar 25. In embodiments, the structure 40 comprises a slotted aperture including a through-hole 45 and slit 50 that extend through the material of the end pieces 30, 35. As is well known in the art, the slotted aperture mates with a guitar button for connecting to the guitar. The invention is not limited to a slotted aperture, however, and any suitable structure 40 may be used for connecting the ends of the first strap 15 to the guitar. In embodiments, the harness 10 includes only two points of attachment to the guitar 25, both points of attachment (e.g., structures 40) being associated with the first strap 15 by way of the first and second end pieces 30 and 35.

According to aspects of the invention, the second strap 20 has a first end 55a that is permanently affixed to the first strap 15 at a location 57 between the first and second ends 33a, 33b of the first strap 15 at location 57. In embodiments, the first end 55a of the second strap 20 is sewn to the first strap 15. However, the invention is not limited to sewing, and any suitable attachment method may be used, such as, for example, providing an adhesive between the straps, weaving the fabric of the straps together, welding material of the straps, providing a plurality of mechanical fasteners such as rivets, staples, etc.

In accordance with aspects of the invention, the first end 55a of the second strap 20 is connected to the first strap 15 at an angle θ such that a “V” shape is formed between the straps 15, 20. In embodiments, the angle θ is a non-zero acute angle defined by the intersection of a longitudinal centerline 60 of the first strap 15 and a longitudinal centerline 65 of the second strap 20. In embodiments, the angle θ has a value in the range of about 63° to about 69°, and preferably is about 66°. In this manner, the first and second straps 15, 20 are angled relative to each other, i.e., not parallel to each other, at the point of attachment of the first end 55a of the second strap 20. This geometry provides a beneficial “V” shape that permits the harness 10 to be comfortably located on the two respective shoulders of the user.

Although the invention is described herein with respect to a “V” shape, this nomenclature is not intended to limit the invention. For example, the junction between the first strap 15 and the second strap 20 may be any suitable shape, such as a “V”, “y”, “Y”, or “U” shape, or any other desired shape.

Still referring to FIG. 2, in embodiments, a third end piece 70 is provided at a second end 55b of the second strap 20. The third end piece 70 is pivotally connected to the first end piece 30 at the first end 33a of the first strap 15. In implementations, the pivotal connection may be provided by any suitable hardware 75 including, but not limited to, a rivet, snap, Chicago screw, etc. For example, the hardware 75 may comprise a connector having respective male and female portions, one of the portion attached to the first end piece 30 and the other one of the portions attached to the third end piece 70, such that when the respective male and female portion engage one another the third end piece 70 is pivotally connected to the first end piece 30.

According to aspects of the invention, the second end 33b of the first strap 15 and the second end 55b of the second strap 20 are each provided with a length adjustment system 80a and 80b, respectively. In embodiments, the length adjustment system 80a (80b) comprises a buckle 85a (85b) and a loop member 90a (90b) through which portions of the straps are routed in a conventional manner that provides a slidable length adjustment system for each strap. For example, the length adjustment system may be configured similar to that shown in U.S. Pat. No. 4,279,367, the entire contents of which are hereby incorporated by reference in their entirety.

As depicted in FIG. 2, the second end piece 35 may be connected to the second end 33b of the first strap 15 by way of the loop element 90a of the length adjustment system 80a. Similarly, the third end piece 70 may be connected to the second end 55b of the second strap 20 by way of the loop element 90b of the length adjustment system 80b. The first end piece 30 may be connected to the first end 33a of the first strap 15 by sewing or other suitable connection method, although a loop member similar to loop member 90a could be used, if desired.

With reference to both FIGS. 1 and 2, in embodiments, the harness 10 is structured and arranged such that the buckle 85b on the second strap 20 is located on the front of a user's body, while the buckle 85a on the first strap 15 is located near the user's hip near the butt-end of the guitar 25. In particular, the buckle 85b is conveniently located in the vicinity of the anchor point 30 near the neck of the guitar 25, whereas the other buckle 85a is conveniently located in the vicinity of the anchor point 30 near the butt-end of the guitar 25. By constructing the harness 10 with the geometry described herein, both length adjustment systems 80a and 80b are accessible by the user when the user is wearing the harness 10. In this manner, the user may easily and conveniently adjust one or both of the length adjustment systems 80a and 80b while wearing the harness 10 without having to remove the harness for such adjustment.

In accordance with aspects of the invention the length adjustment system 80a on the first strap 15 is used primarily for adjusting a height of the guitar 25 relative to the body of the user. By lengthening the first strap 15 using the length adjustment system 80a, the guitar may be lowered on the user's body. In contrast, by shortening the first strap 15 using the length adjustment system 80a, the guitar may be raised on the user's body. In accordance with additional aspects of the invention, the length adjustment system 80b on the second strap 20 is used primarily for adjusting the distribution of weight amongst the user's shoulders. By adjusting the length of the second strap 20 using the length adjustment system 80b, the weight of the guitar may be evenly distributed on the shoulders, or more weight can be selectively applied to one shoulder relative to the other. In this manner, the user may use the length adjustment systems 80a and 80b to configure the adjustable harness 10 in a preferred and most comfortable manner.

In embodiments, when a user adjusts one or both of the length adjustment systems 80a and 80b, the pivot hardware 75 permits a change in an angle α between the first end 33a of the first strap 15 and the second end 55b of the second strap 20. Also, the flexibility of the material of the straps 15, 20 permits a change in the shape of the harness 10 when the length of the one or both of the first and second straps 15, 20 is adjusted. In particular, an angle β, which is defined between the first end 55a of the second strap 20 and the central portion of the first strap 15, may change based upon an adjustment of one or both length adjustment systems 80a and 80b.

In a particular exemplary embodiment, the length adjustment systems 80a and 80b are the only such systems comprised in the harness. For example, the harness 10 may comprise only a single length adjustment system 80a on the first strap 15 and may comprise only a single length adjustment system 80b on the second strap 20. More specifically, the harness 10 may be devoid of length adjustment hardware at the first end 33a of the first strap 15. The first strap 15 may be devoid of buckles, sliders, or other hardware along an entirety of a portion of the first strap extending between the first end piece 30 and the location 57 of attachment of the first end 55a of the second strap 20 the first strap 15. In embodiments, the first buckle 85a, the first loop member 90a, the second buckle 85b, the second loop member 90b, and the connector hardware 75 are the only hardware included in the harness, such that the harness does not include any other hardware such as buckles, loops, slides, rivets, snaps, screws, etc. In this manner, the harness 10 comprises a minimal amount of hardware, which makes the harness 10 more comfortable and easier to use, and which also reduces manufacturing costs. For example, by using only two length adjustment systems 80a and 80b that are both accessible by a user while the user is wearing the harness, implementations of the invention provide an improvement over other instrument straps that include adjustment hardware arranged on the user's back where the user typically cannot reach.

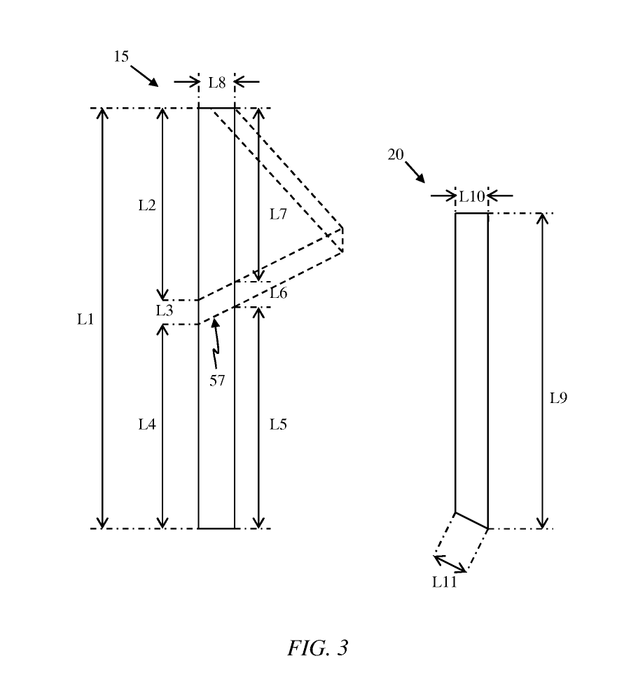

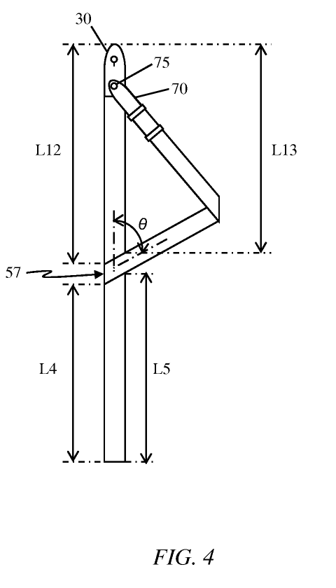

FIGS. 3 and 4 show a diagrammatic representation of aspects of method of manufacturing a harness in accordance with embodiments of the invention. FIG. 3 shows a layout of raw materials for the first strap 15 and the second strap 20. FIG. 4 shows the two straps 15 and 20 after attachment of the first end piece 30 and third end piece 70, and with the straps pivotally connected at hardware 75 and sewn at location 57. Exemplary dimensions L1 through L13 are set forth in Table 1, although the invention is not limited to these dimensions and other suitable dimensions may be used within the scope of the invention.

TABLE 1

| Dimension Label | Inches |
|---|---|
| L1 | 52 |
| L2 | 26 |
| L3 | 2 and ⅛ |
| L4 | 24 |
| L5 | 25 |
| L6 | 2 and ⅛ |
| L7 | 25 |
| L8 | 2 |
| L9 | 34 |
| L10 | 2 |
| L11 | 2 and ⅛ |
| L12 | 29 |
| L13 | 28 |

In accordance with aspects of the invention, a method of making the harness 10 comprises cutting a first piece of material corresponding to the first strap 15 to a length of L1. The length L1 is selected to provide about a one inch insertion of the material into the first end piece 30, as well as about a two inch fold for attaching the material to the first buckle 85a after passing through the first loop member 90a. The method may include connecting the first piece of material to the first end piece 30, e.g., by sewing. The method may further include passing the first piece of material through the first loop member 90a, folding it around a transverse bar of the first buckle 85a, and connecting an end of the first piece of material to an intermediate portion of the first piece of material.

The method may further comprise cutting a second piece of material corresponding to the second strap 20 to a length of L9. A first end of the second piece of material is cut at an angle so that the cut end of the second piece of material is flush with a side of the first piece of material when the second piece of material is connected to the first piece of material at location 57 at angle θ. A second end of the second piece of material is passed through the second loop member 90b, folded around a transverse bar of the second buckle 85b, and connected to an intermediate portion of the second piece of material. The length L9 is selected to provide about a two inch fold for attaching the material to the second buckle 85a.

In embodiments, the method additionally includes connecting the second piece of material to the first piece or material at attachment location 57. The connection may be achieved, for example, by sewing the second piece of material to the first piece of material at attachment location 57 and at the angle θ defined by respective longitudinal centerlines of the first and second pieces of material at the location 57.

The method may further include connecting the second end piece 35 to the first loop member 90a, and connecting the third end piece 70 to the second loop member 90b. The method may further include pivotally connecting the third end piece 70 to the first end piece 30 using connector hardware 75.

In embodiments, the components of the harness 10 may be made of any suitable materials. For example, the straps 15, 20 and end pieces 30, 35, and 70 may be composed of cotton, denim, nylon or other synthetics, leather, or any other suitable material. Moreover, the buckles 85a, 85b and a loop members 90a, 90b may be composed of any suitable materials, such as, for example, metal, plastic, wood, rubber, etc. In a particular non-limiting embodiment, the straps 15, 20 are made of webbing, the end pieces 30, 35, and 70 are leather, and the buckles 85a, 85b and a loop members 90a, 90b are plastic.

The foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A harness for supporting an instrument, the harness comprising:
a first strap;
a first end piece connected to a first end of the first strap;
a second end piece connected to a second end of the first strap;
a second strap, wherein a first end of the second strap is permanently connected to the first strap at a location between the first end of the first strap and the second end of the first strap;
a third end piece connected to a second end of the second strap;
a connector pivotally connecting the third end piece to the first end piece;
a structure in the first end piece structured and arranged to connect the first strap to the instrument, wherein the structure is separate from the connector;
a first length adjustment system associated with the first strap, wherein the first length adjustment system adjusts a position of the instrument relative to a body of a user wearing the harness; and
a second length adjustment system associated with the second strap, wherein the second length adjustment system adjusts a distribution of weight amongst two shoulders of the user wearing the harness.

2. The harness of claim 1, wherein the first end of the second strap is connected to the first strap at an acute, non-zero angle relative to the first strap.

3. The harness of claim 2, wherein the angle is defined by a longitudinal centerline of the second strap and a longitudinal centerline of the first strap at the location where the second strap is connected to the first strap.

4. The harness of claim 3, wherein:
wherein the first strap is devoid of hardware along an entirety of a portion of the first strap extending between the first end piece and the location; and
the first length adjustment system and the second length adjustment system are the only length adjustment systems associated with the harness.

5. The harness of claim 3, wherein the angle is in a range of about 63° to about 69°.

6. The harness of claim 1, wherein an entirety of a portion of the first strap extending between the location and the first end piece is devoid of adjustment hardware.

7. The harness of claim 1, wherein the first strap is devoid of buckles, sliders, and other hardware along an entirety of a portion of the first strap extending between the first end piece and the location.

8. The harness of claim 1, wherein the first length adjustment system and the second length adjustment system are the only length adjustment systems associated with the harness.

9. The harness of claim 1, wherein:
the first strap and the second strap comprise webbing;
the first, second, and third end pieces comprise leather;
the first end of the second strap is sewn to the first strap; and
the connector comprises a rivet, snap, or Chicago screw.

10. The harness of claim 1, wherein:
the second length adjustment system is structured and arranged to be located at a chest of a user wearing the harness; and
the first length adjustment system is structured and arranged to be located at a hip of the user wearing the harness.

11. A harness for supporting an instrument, the harness comprising:
a first strap;
a first end piece connected to a first end of the first strap;
a second end piece connected to a second end of the first strap;
a second strap, wherein a first end of the second strap is permanently connected to the first strap at an attachment location between the first end of the first strap and the second end of the first strap;
a third end piece connected to a second end of the second strap;
a connector pivotally connecting the third end piece to the first end piece;
a structure in the first end piece structured and arranged to connect the first strap to the instrument, wherein the structure is separate from the connector;
a first length adjustment system associated with the first strap; and
a second length adjustment system associated with the second strap,
wherein the first strap is devoid of hardware along an entirety of a portion of the first strap extending between the first end piece and the attachment location.

12. The harness of claim 11, wherein:
wherein the first length adjustment system adjusts a position of the instrument relative to a body of a user wearing the harness; and
the second length adjustment system adjusts a distribution of weight amongst two shoulders of the user wearing the harness.

13. The harness of claim 11, wherein the first end of the second strap is connected to the first strap at an acute, non-zero angle relative to the first strap.

14. The harness of claim 13, wherein the angle is defined by a longitudinal centerline of the second strap and a longitudinal centerline of the first strap at the location where the second strap is connected to the first strap.

15. The harness of claim 11, wherein:
the first length adjustment system comprises a first buckle and a first loop member;
the second length adjustment system comprises a second buckle and a second loop member; and
the harness comprises hardware consisting of: the first buckle, the first loop member, the second buckle, the second loop member, and the connector.

16. The harness of claim 11, wherein the harness comprises hardware including only the first length adjustment system, the second length adjustment system, and the connector, and the harness is devoid of any other hardware.

17. The harness of claim 11, wherein:
the second length adjustment system is structured and arranged to be located at a chest of a user wearing the harness; and
the first length adjustment system is structured and arranged to be located at a hip of the user wearing the harness.

18. A method, wherein the method comprises making the harness of claim 11.

19. The method of claim 18, wherein the making comprises:
cutting a first piece of material corresponding to the first strap;
cutting a second piece of material corresponding to the second strap; and
sewing the second piece of material to the first piece of material.
